(19) United States
(12) Patent Application Publication
(10) Pub. No.: US 2026/0106232 A1
(43) Pub. Date: Apr. 16, 2026

(54) SELF-CORRECTIVE BATTERY MANAGEMENT SYSTEM

(71) Applicant: Oxford Brookes University, Oxford (GB)

(72) Inventors: Shahaboddin RESALATI, Oxford (GB); Farhad SALEK, Oxford (GB)

(73) Assignee: Oxford Brookes University, Oxford (GB)

(21) Appl. No.: 18/913,775

(22) Filed: Oct. 11, 2024

(51) Int. Cl. H01M 10/42; H01M 10/48

(52) U.S. Cl. CPC H01M 10/425; H01M 10/482; H01M 10/486; H01M 2010/4271; H01M 2220/20

(57) ABSTRACT

A method of managing battery modules in a circuit may include producing a state-of-health (SOH) estimation through a controller for a plurality of battery cells based on a current, a voltage, and a temperature of each battery cell, in each of the battery modules, storing the current, the voltage, and the temperature of each of the battery cells as SOH historical data for the battery cell, generating an SOH prediction for each of the battery cells based on the SOH historical data of the battery cell, and comparing the SOH estimation to the SOH prediction. Where the SOH estimation is within a predetermined threshold of the SOH prediction, performing an SOH balancing between the one or more battery cells in the battery modules.

### FIELD OF INVENTION

The present invention relates generally to battery management technologies and more particularly to the state-of-health management in first and second life battery packs.

### BACKGROUND

The lithium-ion batteries of electric vehicles (EVs) are retired when they reach approximately 80% of their initial capacity. There is a potential for reusing the batteries in other less-stressed applications, such as stationary energy storage systems in buildings. However, there are many technical challenges envisaged with using such batteries for stationary energy storage application, such as heterogeneous states of health of the lithium-ion cells and modules coming from various EVs. In addition, the degradation trend of the battery cells and modules during their first-life application in EVs affects their second life. The unknown aging history of the second-life battery cells and modules retired from electric vehicles results in cell-to-cell and module-to-module parameter variations, subsequently leading to failure of battery operation and thermal runaways. This safety issue has led to reluctance among insurance companies to provide coverage for second-life battery systems, which currently stands as a major obstacle to introducing this technology to the market. Accordingly, the state of health of the second-life battery cells and modules exhibiting heterogeneous states of health need to be managed and balanced during operation.

### SUMMARY OF THE INVENTION

A method of managing battery modules in a circuit may include producing a state-of-health (SOH) estimation through a controller for a plurality of battery cells based on a current, a voltage, and a temperature of each battery cell, in each of the battery modules, storing relevant data such as the current, the voltage, and the temperature of each of the battery cells as SOH historical data for the battery cell, generating an SOH prediction for each of the battery cells based on the SOH historical data of the battery cell, and comparing the SOH estimation to the SOH prediction. Where the SOH estimation is within a predetermined threshold of the SOH prediction, performing an SOH balancing between the one or more battery cells in the battery modules. In one embodiment, the battery management system further comprises one or more voltage sensor configured to measure voltages of each battery cell.

The accompanying drawings, which are incorporated in and constitute a part of the specification, illustrate various example systems, methods, and so on, that illustrate various example embodiments of aspects of the invention. It will be appreciated that the illustrated element boundaries (e.g., boxes, groups of boxes, or other shapes) in the figures represent one example of the boundaries. One of ordinary skill in the art will appreciate that one element may be designed as multiple elements or that multiple elements may be designed as one element. An element shown as an internal component of another element may be implemented as an external component and vice versa. Furthermore, elements may not be drawn to scale.

### BRIEF DESCRIPTION OF THE DRAWINGS

FIG. 1 illustrates a block diagram of an example battery management system.

FIG. 2 illustrates a flowchart of steps for state-of-health balancing and prediction.

FIG. 3 illustrates a flowchart of steps for a current restriction method based on an estimated and predicted state of health and state of power for each cell.

FIG. 4 illustrates a plurality of first life/second life battery modules in a pack in a series configuration, and the active balancing system components.

FIG. 5 illustrates a plurality of first life/second life battery modules in a pack in a parallel configuration, and the active balancing system components.

FIG. 6 illustrates an example graph displaying predicted state-of-health (SOH) values compared to predicted SOH values with aging knee point detection.

FIG. 7 illustrates a decision-making method of beginning a safety procedure based on a sudden change of a predicted state-of-health (SOH) line slope variation.

FIG. 8 illustrates a block diagram of a battery system equipped with an active balancing system and a self-corrective smart battery management system.

FIG. 9 illustrates a plurality of first life/second life battery active balancing of the system switch mechanism.

### DETAILED DESCRIPTION

Embodiments of the proposed invention recognize that second life batteries degrade due to various different operating parameters such as current applied to the cells and temperature of the cells. Second life battery packs contain second life battery cells and modules retired from electric vehicles after they have been degraded to 80% of their initial capacity. These battery cells and modules can be collected and repurposed to be used for second life, less stress applications, such as building energy storage systems. However, there are lots of challenges envisaged with employment of secondary life batteries in stationary storage system applications, including safety concerns raised from sudden thermal runway. Due to such sudden failure modes, insurance companies may be reluctant to insure facilities employing second life batteries, which is one of the main barriers for this technology at the moment. In the proposed invention, a method has been developed which estimates the state of health (SOH) of second life battery cells and modules, and predicts its values under different electrical loads and thermal stress. Main goals of the present invention include adequately predicting SOH, detecting end of life, and managing the battery accordingly to prolong useful life and enhance safety.

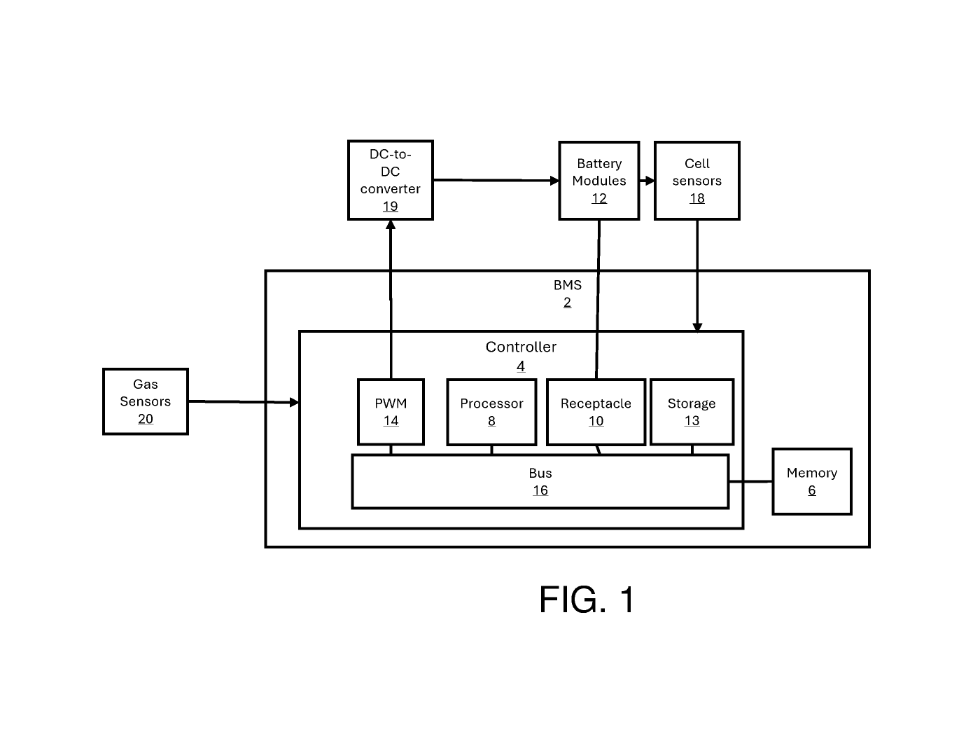

FIG. 1 illustrates a block diagram of a battery management system (BMS) 2. The BMS 2 includes a controller 4 and a memory 6. Controller 4 contains a processor 8, a receptacle 10 for receiving a plurality of battery modules 12, a storage 13, and a pulse width modulator (PWM) 14, all operably connected by a bus 16. Cell sensors 18 measure diagnostic data from battery modules 12 and transmit the data to the controller 4. The diagnostics include parameters which may include the voltage, current, and/or temperature of the cell. Gas sensors 20 located proximate to the battery modules 12 detect CO₂ and/or H₂ gas leakage from the battery modules 12 by measuring the CO₂ and H₂ gas fraction levels that are transmitted to the controller 4. The diagnostic battery module sensor data and the gas fraction level data are used by controller 4 to determine if one of the battery modules 12 needs to be disconnected or otherwise managed in system 2. In the event that the controller 4 determines that current of one or more of the battery modules 12 needs to be reduced, the PWM 14 sends signals varying between high and low state such that the corresponding DC-DC Converter 19 modulates current of the battery module 12 to a desired safe level. In the event that the controller 4 determines that one or more of the battery modules 12 is faulty and needs to be disconnected, the PWM 14 sends signals to the corresponding DC-DC Converter 19 to act such that the battery module 12 is effectively removed from the system 2. Although for ease of explanation the PWM 14 is described herein as pulse width modulation, other modulation techniques (e.g., pulse frequency modulation, pulse density modulation, etc.) are envisioned instead of or in addition to pulse width modulation.

The processor 8 can be a variety of various processors including dual microprocessor and other multi-processor architectures. Memory 6 can include volatile memory or non-volatile memory. The non-volatile memory can include, but is not limited to, ROM, PROM, EPROM, EEPROM, and the like. Volatile memory can include, for example, RAM, synchronous RAM (SRAM), dynamic RAM (DRAM), synchronous DRAM (SDRAM), double data rate SDRAM (DDR SDRAM), and direct RAM bus RAM (DRRAM). Storage 13 may be operably connected to processor 8 via the bus 16. The storage 13 can include, but is not limited to, devices like a magnetic disk drive, a solid-state disk drive, a flash memory card, or a memory stick. Memory 6 can store processes or data.

The bus 16 can be a single internal bus interconnect architecture or other bus or mesh architectures. While a single bus is illustrated, it is to be appreciated that the battery management system 2 may communicate with various devices, logics, and peripherals using other buses that are not illustrated (e.g., PCIE, SATA, Infiniband, 1394, USB, Ethernet). The bus 16 can be of a variety of types including, but not limited to, a memory bus or memory controller, a peripheral bus or external bus, a crossbar switch, or a local bus. The local bus can be of varieties including, but not limited to, an industrial standard architecture (ISA) bus, a microchannel architecture (MCA) bus, an extended ISA (EISA) bus, a peripheral component interconnect (PCI) bus, a universal serial (USB) bus, and a small computer systems interface (SCSI) bus.

In the present invention, system 2 may be operated to use data provided by the cells’ voltage, current and temperature sensors 18 to estimate the second life cells and modules SOH and achieve SOH balancing.

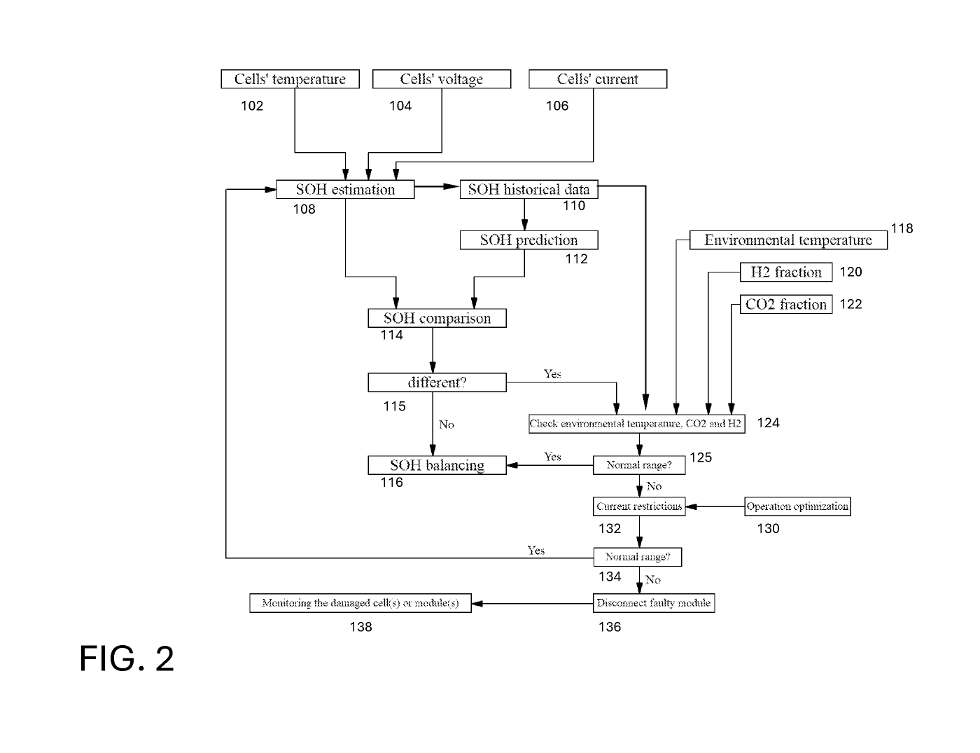

FIG. 2 shows a flowchart regarding steps for state-of-health (SOH) balancing. Sensors 18 connected to a battery cell of module 12 measure sensor information such as, for example, a temperature 102, voltage 104, and current 106 of the battery cell. This sensor information may then be used at 108 to estimate SOH of the battery.

In one embodiment, a Kalman filter may be used for estimating the state-of-health (SOH) of the battery module 12. Using a Kalman filter to estimate the SOH of the battery may involve a systematic process that begins with defining key state variables such as state of charge (SOC), internal resistance, capacity loss, an SOH indicator, etc. The process model describes how these variables evolve over time, considering factors like charging/discharging currents and temperature, and includes an element of uncertainty to account for model imperfections. A measurement model is then developed to relate the sensor readings (voltage, current, and temperature) to these state variables, incorporating measurement noise to reflect sensor inaccuracies. The Kalman filter may be initialized with initial estimates for the state variables and their uncertainties, providing a starting point for estimation and updates. During the estimation step, the filter may use the process model to forecast the next state of the battery, estimating the associated uncertainty. In the update step, the filter may adjust its estimations using actual sensor measurements, calculating the innovation (difference between estimated and actual measurements) and incorporating this innovation into the state estimates, weighted by the Kalman gain. This process refines the state estimates and reduces uncertainty.

In practical terms, sensors 18 continuously collect data on voltage 104, current 106, and temperature 102 from the battery cells of the module 12. The Kalman filter, initialized with starting estimates, estimates the next state of the battery and updates these estimations based on real-time sensor data, refining estimates of SOC, internal resistance, capacity loss, and SOH. For example, the voltage measurement might be related to SOC and internal resistance through Ohm's Law and the battery's equivalent circuit model. By continuously applying this prediction and update cycle, the Kalman filter provides accurate, real-time estimates of the battery's SOH.

In other embodiments, techniques different from Kalman filters may be used for estimating the SOH of the battery module 12 that also aim to provide accurate estimates. Alternative methods may include particle filters (also known as Sequential Monte Carlo methods), machine learning techniques (such as neural networks, support vector machines, and decision trees), fuzzy logic systems, and state observers (e.g., Luenberger observers). While Kalman filters are a powerful tool for SOH estimation, these alternative techniques may provide different strengths and capabilities. Combining these techniques or using hybrid approaches may also enhance the overall performance and reliability of the system 2 SOH estimation at 108.

As more sensor data is gathered over time, the previously used SOH data may be stored as SOH historical data 110. The historical SOH data 110 logged with the temperature, voltage and current of the cells may be used for predicting the SOH of each cell and module 12 individually. SOH prediction 112 may be accomplished using an AI-based algorithm such as a neural network programmed in the controller 4. At 114, at each cycle of charging and discharging of the second life battery pack, the real-time estimated SOH 108 data may be compared to the predicted SOH 112. At 115, a determination may be made as to how different the estimated SOH 108 and the predicted SOH 112 are. The comparison and difference determination 114, 115 may be implemented on fuzzy logic.

Using fuzzy logic to compare and determine the difference 115 between the estimated SOH 108 and the predicted SOH 112 of the battery may involve a structured approach. First, fuzzy sets may be defined for the input variable, which is the difference between the real-time estimated SOH 108 and the AI-predicted SOH 112 (ΔSOH). These fuzzy sets might include categories such as "Actionable Difference" and “Non Actionable Difference.” Similarly, for the output variable, which is the action to be taken, the fuzzy sets could include “No Adjustment Needed" and “Adjustment Needed.” The next step is fuzzification, where the crisp input value (ΔSOH) is converted into degrees of membership for each fuzzy set. For example, if the difference between the estimated SOH 108 and predicted SOH 112 is 5%, this value would be assessed for its degree of belonging to the "Actionable Difference” or “Non Actionable Difference" sets. Following fuzzification, a set of if-then rules that govern the fuzzy logic system may be defined. These rules establish the relationship between input and output fuzzy sets, such as "If ΔSOH is Actionable Difference, then Action is Adjustment Needed," or "If ΔSOH is Non Actionable Difference, then Action is No Adjustment Needed." In the inference step, the fuzzy rules are applied to infer the fuzzy output based on the fuzzified inputs. This involves evaluating all applicable rules and combining their results to form a fuzzy output, typically using operations like min (AND) and max (OR) to compute the degree of membership for each output fuzzy set. Finally, defuzzification converts the fuzzy output back into a crisp value that can be used for decision-making. Common methods for defuzzification include the centroid method, which calculates the center of gravity of the output fuzzy set, and the maximum method, which selects the value with the highest degree of membership. In practice, this process involves gathering real-time estimated SOH 108 and AI-predicted SOH 112 data for each charging and discharging cycle, calculating the difference (ΔSOH), and then fuzzifying this difference. For instance, a ΔSOH of 2% may belong to the "No Actionable Difference" set. Applying the fuzzy rules might result in an action leaning towards "No Adjustment Needed" if the difference is mostly considered small. This method offers a flexible and intuitive way to handle uncertainties and variations in the SOH data.

At 115, if the state-of-health (SOH) estimation 108 is within a predetermined threshold of the SOH prediction 112 (i.e., No Actionable Difference), then an SOH balancing 116 may be performed. SOH balancing 116 refers to the process of equalizing the capacities (i.e., minimizing the capacity difference) and performance characteristics of individual cells within a battery module 12 to maximize the overall health and longevity of the battery pack. As batteries age, individual cells may degrade at different rates due to factors such as manufacturing variations, operating conditions, and cycling history. This can lead to capacity imbalances, reduced energy storage capacity, and overall degradation of the performance of the battery pack. Capacity imbalance refers to the fact that battery cells tend to degrade heterogeneously with some cells degrading at a faster rate than others in the same module. SOH balancing 116 aims to mitigate these imbalances by ensuring that all cells in module 12 are operating at similar levels of capacity and performance, attempting to make degradation similar for all cells.

At 115, if the SOH estimation 108 exceeds a predetermined threshold (i.e., Actionable Difference), then additional diagnostics may be performed at 124. A thermal runaway point (including, for example, historical temperature, voltage, and current data) may be calculated by using SOH historical data 110. Environmental temperature data 118, which is the temperature in the vicinity of the battery module 12, and H₂120 and CO₂122 gas fraction levels are measured from sensors 18. When battery module 12 undergoes thermal runaway or overcharging, the temperature rises rapidly, causing the electrolyte to decompose and release flammable gases, such as H₂120 gas. However, even before thermal runaway occurs, a first venting occurs where the internal pressure of the battery cell exceeds a critical value and the pressure burst disk opens. During this first venting, the highest concentration of vent-gases released from the battery cell are H₂120 and CO₂ 122. As such, measuring H₂120 and CO₂122 gas can help detect battery failure even before thermal runaway has occurred. Measuring the environmental temperature data 118 can detect issues with the battery module 12 in the event the battery module 12 emits enough heat to affect the surroundings of the battery module 12.

At 125, if the environmental temperature data 118, and H₂ 120 and CO₂122 gas fraction levels are within an acceptable threshold, then SOH balancing 116 is performed for harmonized degradation of the cells and modules 12. The harmonized degradation allows the battery modules 12 to all decay at a rate that minimizes their SOH differences, with the goal of the batteries reaching their end of life together, despite starting at different battery health. Thus, the system 2 seeks to correct the limitations of the conventional SOH balancing algorithm modules in which modules will not decay at the same rate, to a more harmonized rate of decay for all modules. However, at 125, if the values are not within an acceptable range, then the battery cell undergoes current restrictions 132. Operation optimization 130 determines how the currents are restricted, as described below.

After restricting the current at 132, at 134, if the environmental temperature data 118, and H₂120 and CO₂122 gas fraction levels are within an acceptable threshold, the cycle restarts with the battery cell undergoing SOH estimation 108. If, however, the environmental temperature data 118, and H₂120 and CO₂122 gas fraction levels do not return to an acceptable range and/or if the cycle continues multiple times and the current restrictions 132 are not allowing the SOH estimation 108 to equal (or be very similar to) the SOH prediction 112 (the same result after various cycles indicates a faulty module 12), then the cycle breaks out of the loop and proceeds to step 136 where the battery module 12 may be disconnected from the battery pack because it may have reached its end of life. The faulty module 12 may continue to undergo monitoring 138 even when it is disconnected from the battery pack.

A current restriction method may also be developed and programmed in the proposed microcontroller 8 with operation optimization in mind. In this method, the cells’ voltage and current values may be used to estimate the state of power (SOP) of each cell in the modules and the module’s own state of power (SOP). In addition, the load applied to the battery pack data given by the inverter/converter may be used to estimate battery pack load demand. The estimated load demand applied to the pack and SOP values may be used to predict the SOP of each cell. The prediction may be performed using neural-network based algorithms programmed in the proposed microcontroller 8. If there is no difference between the estimated and predicted values of SOP, the SOH may be predicted. When there is a difference between the estimated and predicted values of SOP, controller 8 may modify the applied current to each cell based on the predicted current values.

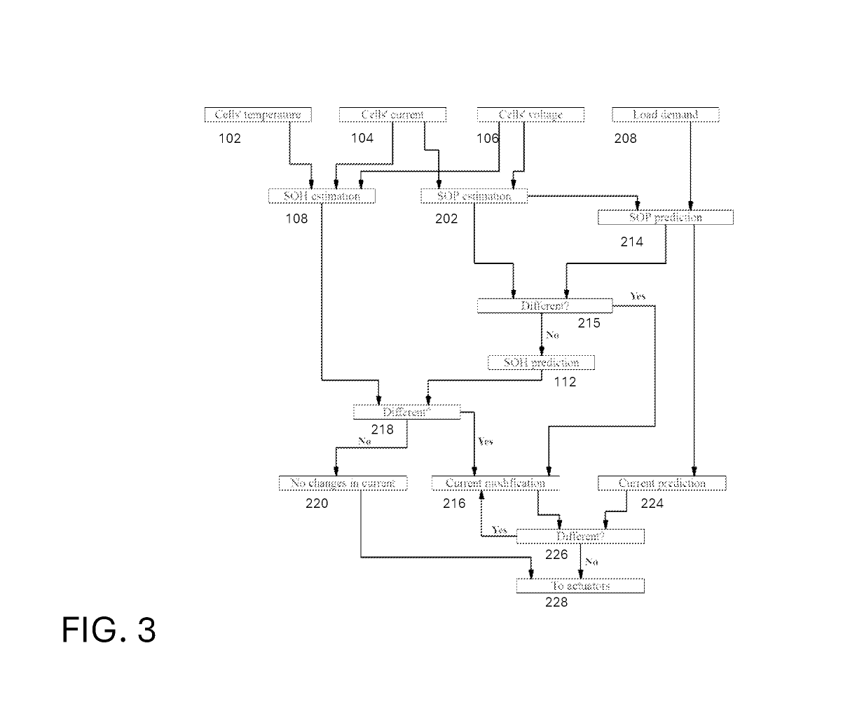

FIG. 3 shows a flowchart regarding steps for current restrictions with operation optimization as shown in FIG. 2. SOH estimation 108 may be calculated using temperature 102, current 104, and voltage 106 data measured from sensors installed to the battery cell, as described above. In addition, a state-of-power (SOP) estimation 202 may be calculated using the voltage 106 and current 104 data of the cell. The SOP is the maximum power that can be released or absorbed steadily by the power battery within a fixed time interval. Simultaneously, the load applied to the battery pack data given by the inverter/converter may be used to estimate a battery-pack load demand 208. The load demand 208 is compared with the SOP estimation 202 to create an SOP prediction 214. At 215, the SOP estimation 202 is compared to the SOP prediction 214 and, if the estimation exceeds a predetermined threshold, the battery cell undergoes current modification 216. If the SOP estimation is within a predetermined threshold, an SOH prediction 112 may be calculated. At 218, the SOH prediction 112 is then compared to the SOH estimation 108 calculated at the start. If the SOH prediction 112 and SOH estimation 108 differ beyond a threshold amount, the current of the corresponding battery cell undergoes current modification 216. Otherwise, at 220, no changes in current occur and actuators 228 may be kept in the current position. Current modification 216 is an iterative process. At 224, a current prediction is calculated based on the SOH prediction 112. At 226, the current as modified 216 is compared to the current prediction 224. If the difference remains above the threshold, current modification 216 is repeated. Once the current modified 216 and the current prediction 224 are similar, current modification stabilizes and a signal may be sent to the actuators 228 to keep the corresponding battery module in service.

In one embodiment, a constant resistance balancing system may be used to balance the SOC of the battery modules. The architecture of a battery module with constant resistance balancing system may include constant resistances connected in parallel to each cell. In a pack level control layer, actuators between each series module may be used that are in parallel with a normally close (NC) switch which is controlled by the BMS 2. When inclement thermal runaway is sensed by the BMS 2 for one of the modules in the second life battery pack, the faulty module may be disconnected using the NC switch controlled by the BMS 2. For second life battery packs consisting of only series modules, a normally open switch may be installed in parallel with each module which disconnects the following module in case of thermal runaway detection by the BMS 2.

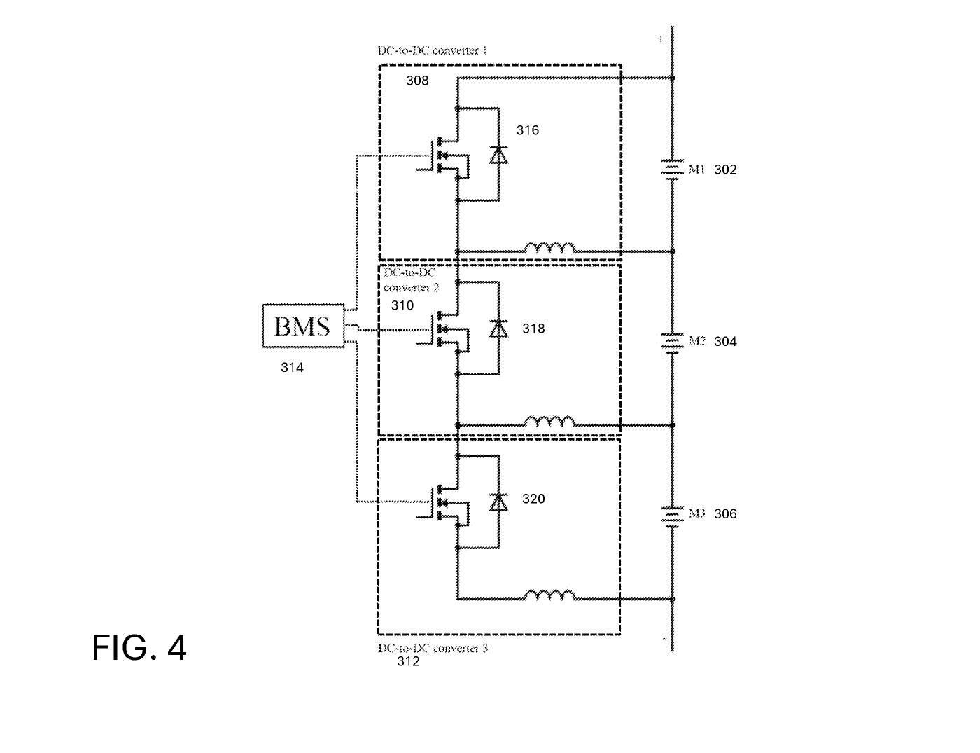

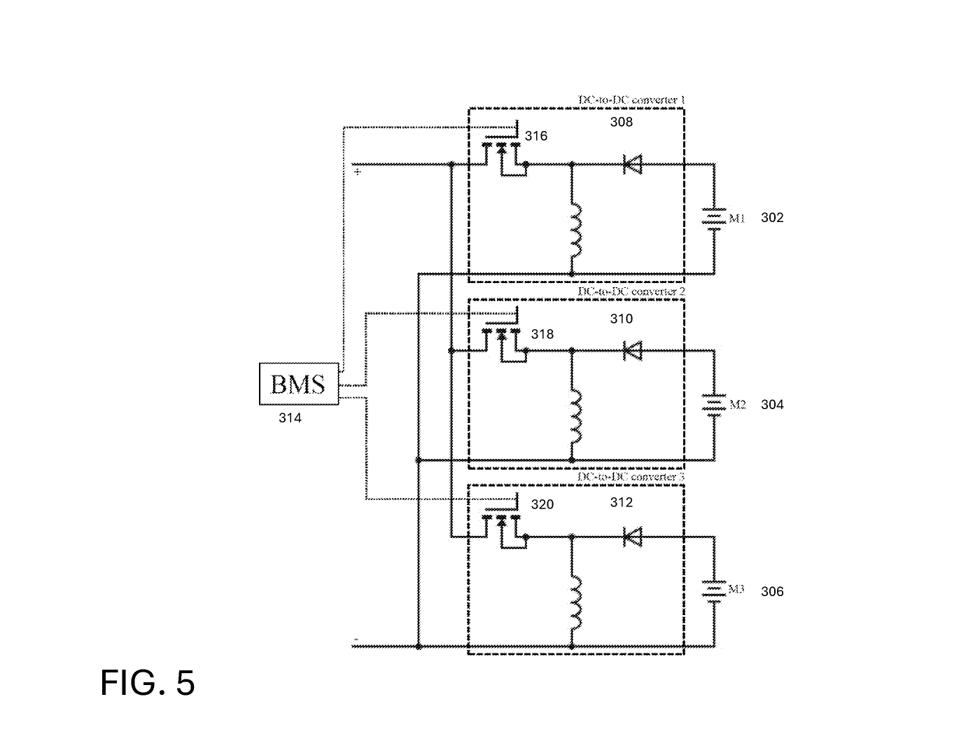

FIGS. 4 and 5 show different configurations for the battery modules 12 and DC-DC Converters 19. In FIG. 4, second life batteries 302, 304, 306 and DC-to-DC converters 308, 310, 312 (similar to DC-DC converter 19 of FIG. 1) are arranged in a series configuration. In FIG. 5, the batteries 302, 304, 306 and DC-to-DC converters 308, 310, 312 are arranged in a parallel configuration. A battery management system (BMS) 314 (similar to BMS 2 of FIG. 1) may be connected to each switch 316, 318, 320 of the DC-to-DC converters 308, 310, 312. The switches 316, 318, 320 may be metal-oxide-semiconductor field-effect transistor (MOSFET), bipolar transistors (BJT), insulated-gate bipolar transistors (IGBT), etc. that act as switches, effectively toggling the bypass resistors of the battery cell or modules 302, 304, 306 on and off. The battery management system 314 operably connects to each switch 316, 318, 320 of the DC-to-DC converters 308, 310, 312 to effectively control the DC-to-DC converters.

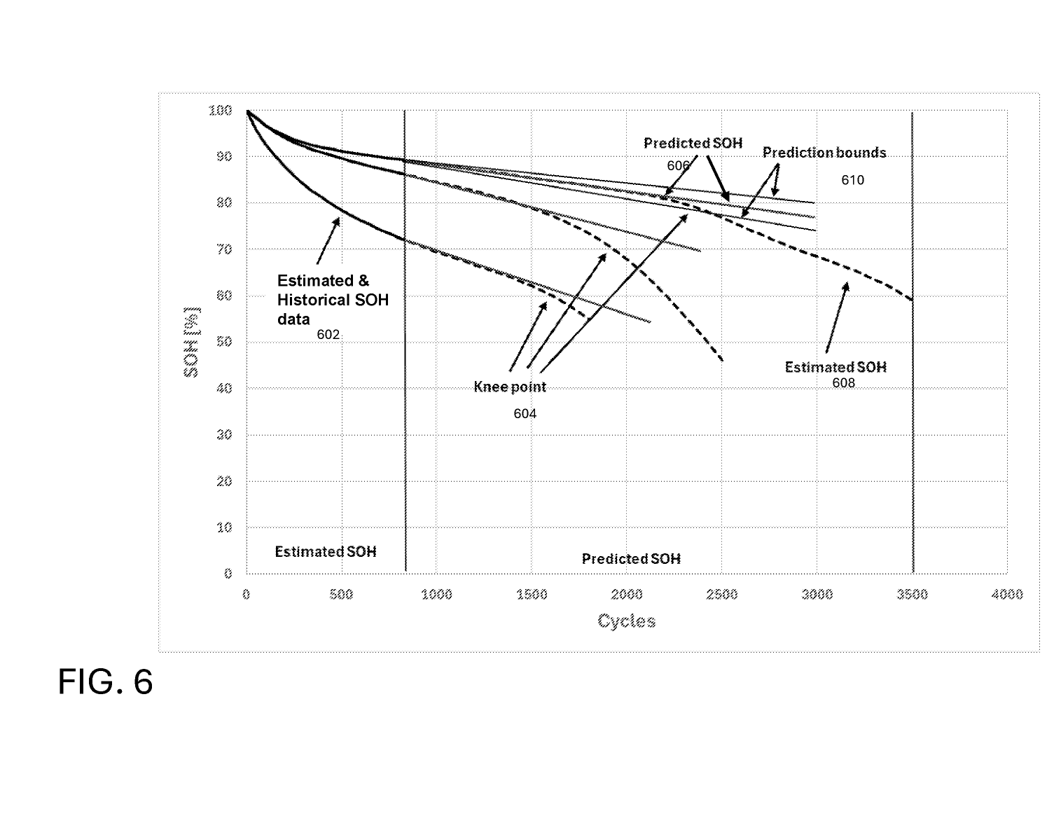

FIG. 6 shows an example graph displaying a predicted state-of-health (SOH) compared to a measured SOH. The graph is divided into two segments. The first segment closest to the origin shows a state-of-health (SOH) based on measured and historical SOH data 602. The second segment no longer includes historical SOH data, and instead shows a comparison between the predicted SOH 606 (solid line) to the measured estimated SOH 608 (dashed line). Several examples of knee points 604 are shown on the graph that demonstrates when the predicated SOH 606 exceeded a set threshold in respect to the measured SOH 608. The example knee points 604 refer to a specific state-of-charge (SOC) at which the voltage of the battery cell undergoes a rapid change. When the battery is charged or discharged, its voltage changes gradually as the SOC increases or decreases. However, at the knee points 604, the voltage changes more rapidly which signals a transition in the behavior of the battery towards failure. If/when the system 2 recognizes the knee point 604, the corresponding DC-to-DC converter may be used to disconnect the module containing the failed/nearly failed cell from the system 2 through sending a permanent off pulse to the relevant DC-to-DC converter.

The predicted SOH 606 and the probability of knee point 604 detection may be assessed by a microcontroller using a fuzzy logic algorithm. The fuzzy logic algorithm may contain the logics and the limits of various relevant parameters. The normal or not normal states may be determined by the fuzzy logic algorithm by referring to the load applied and its interactions with the operating battery parameters such as depth of discharge (DOD) and temperature. As the output of this algorithm, it will assess the probability of knee point in various time steps. The logic may predict multiple different scenarios for SOH and their respective probabilities. When the probability exceeds the predefined thresholds, the microcontroller may send off specific pulses to the relevant module’s DC-to-DC converter to temporarily shut down the module containing malfunctioning cells.

The estimated SOH historical data 602 may be processed using a neural network, machine learning algorithm, or time-series statistical algorithm to predict the SOH based on historical trends. This prediction 606 is accompanied by upper and lower confidence bounds 610, as illustrated in FIG. 6. The prediction model's output is not a single point estimate but a range, providing upper and lower bounds that reflect the uncertainty inherent in the prediction process. The bounds 610 are derived from the statistical properties of the differences between the predicted and estimated SOH values, ensuring a probabilistic interpretation of the model’s predictions.

The predicted SOH 606 is rigorously compared with the estimated SOH 608 at various time intervals using advanced fuzzy logic algorithms. These algorithms quantitatively assess the deviation between the predicted SOH 606 and the estimated SOH 608, which are graphically represented by the solid line and the dashed line, respectively in FIG. 6. This deviation analysis is critical for understanding the performance and reliability of the SOH predictions. The fuzzy logic algorithm evaluates several parameters to determine the cause of the deviation. These parameters include, but are not limited to, temperature fluctuations, discharge rates, charge cycles, and other environmental and operational conditions.

Furthermore, the fuzzy logic algorithm is designed to calculate the probability of the ageing knee pints 604 based on the percentage deviation between the estimated SOH 608 and predicted SOH 606, as well as the variations in different environmental and physical parameters. The algorithm continuously monitors these deviations over multiple cycles or time intervals, adjusting the ageing knee probability in response to real-time data. This adaptive approach ensures high accuracy in predicting critical ageing phenomena, facilitating proactive maintenance and extending the lifespan of the battery system.

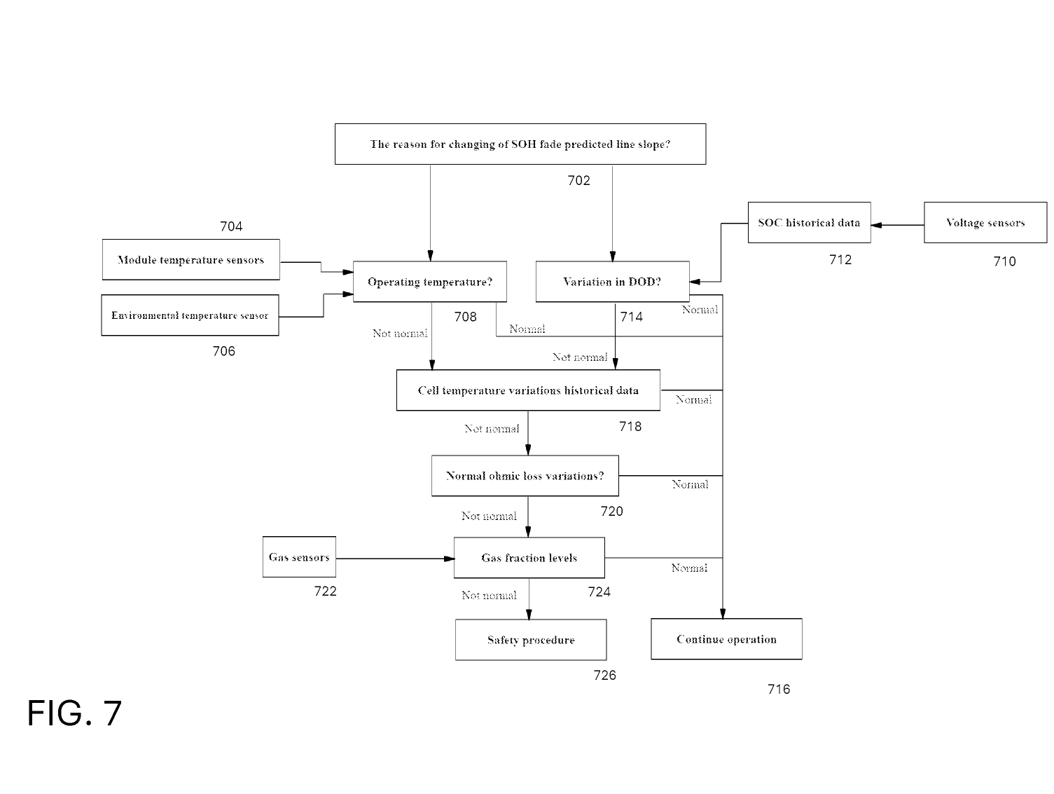

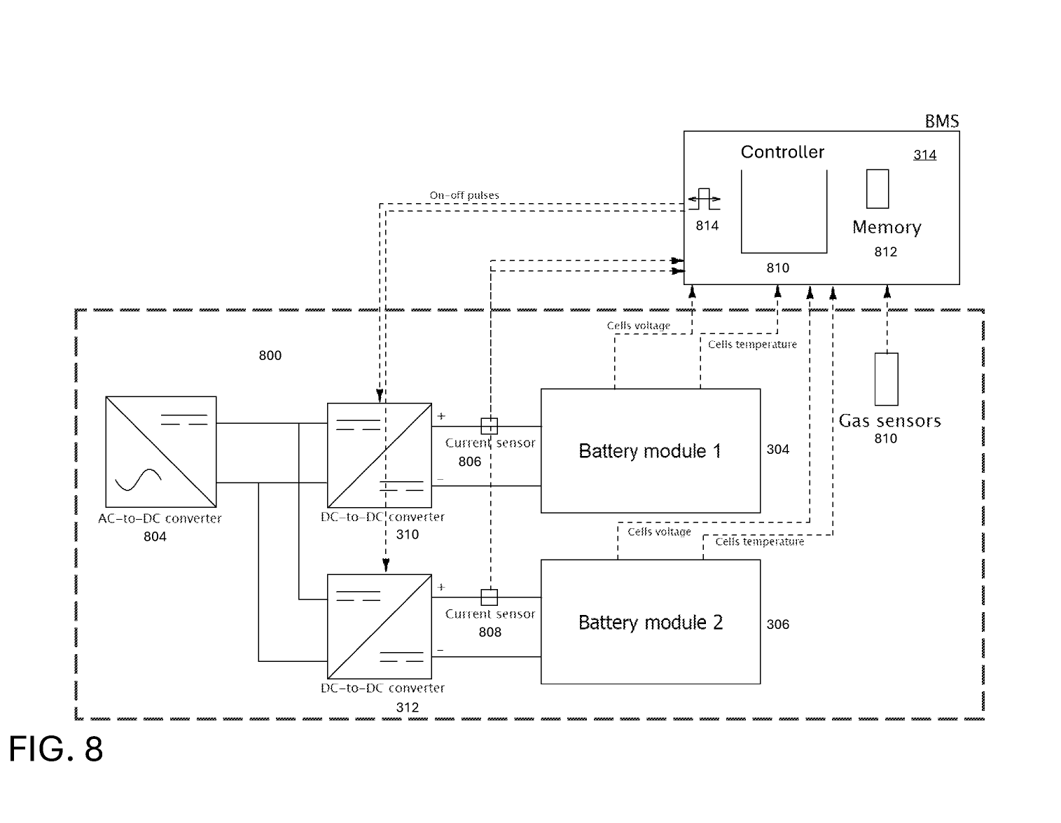

FIGS. 7 and 8 illustrate a decision-making method and a circuit, respectively, for beginning a safety procedure based on a sudden change of a predicted state-of-health (SOH) line slope variation. A controller may use a fuzzy logic algorithm to determine how to detect a knee point 702. The fuzzy logic algorithm contains the logics and the limits of various parameters, such as temperature, voltage, and gas fraction levels of CO₂ and H₂. If the parameters are deemed abnormal, the safety procedure is initiated. When the safety procedure is initiated, the PWM 14 (FIG. 1) sends signals to the DC-to-DC converter 310, 312 to cause the battery module 12 (FIG. 1) to toggle off. When the battery is powered off, it is disconnected from the remaining battery modules 12 (FIG. 1).

Module temperature sensors 704 and environmental temperature sensors 706 feed temperature data regarding the temperature within the battery and temperature in the vicinity of the battery to the controller 810. The controller at 708 determines whether the operating temperature is abnormal based on the data sheet for the battery. Meanwhile, voltage sensors 710 send voltage data to the controller where at 712, the voltage data is converted into state-of-current (SOC) historical data. The controller at 714 determines whether there is any variation in the depth of discharge (DOD). DOD is the percentage of a capacity of the battery that has been discharged relative to its total capacity. DOD indicates how much energy has been extracted from the battery during a particular discharge cycle. As such, any variation in the DOD can show that the battery is draining faster than expected, and therefore is likely not operating correctly. Detecting a normal operating temperature or no variation in DOD will result in continued operation 716. If either the temperature in 708 or DOD in 714 are not normal, the controller proceeds with comparing the temperature variations with historical data at 718. Normal results will result in continued operation 716, whereas abnormal results will cause the controller to check for any abnormal ohmic loss variations at 720. As ohmic loss is due to the resistance to the flow of electrons in the electrodes and protons in the electrolyte, an abnormally large loss can signify that the current 104 has exceeded a max amount stated in the battery module 302, 304, 306 (FIGS. 4 and 5) datasheets of the battery module 302, 304, 306. If there are abnormal ohmic loss variations, the controller will proceed to read values taken from gas sensors 722. If the gas fraction levels 724 are normal, the controller continues operation 716. However, if the gas fraction level 724 is abnormal, the controller initiates a safety procedure 726. The controller sends PWM 14 (FIG. 1) sends signals such that the battery module 12 (FIG. 1) is toggled off.

FIG. 8 shows a block diagram of the battery management system (BMS) 314 and the active balancing system 800. The combination of BMS 314 and active balancing system 800 contains an AC-to-DC converter 804, DC-to-DC converters 310, 312, battery modules 304, 306, current sensors 806, 808, and gas sensors 809. The BMS 314 may contain a controller 810, memory 812, and a pulse width modifier 814. The voltage and temperature of the battery modules 304, 306 are sent to the BMS 314. The battery modules 304, 306 are connected to separate DC-to-DC converters 310, 312. Current sensors 806, 808 run between the battery modules 304, 306 and DC-to-DC converters 310, 312 to transmit the current to the controller 810. Gas sensors 809 measure H₂and CO₂ gas to transmit to the controller 810. The AC-to-DC converter 804 receives DC current from the DC-to-DC converter 310, 312 and converts it to AC.

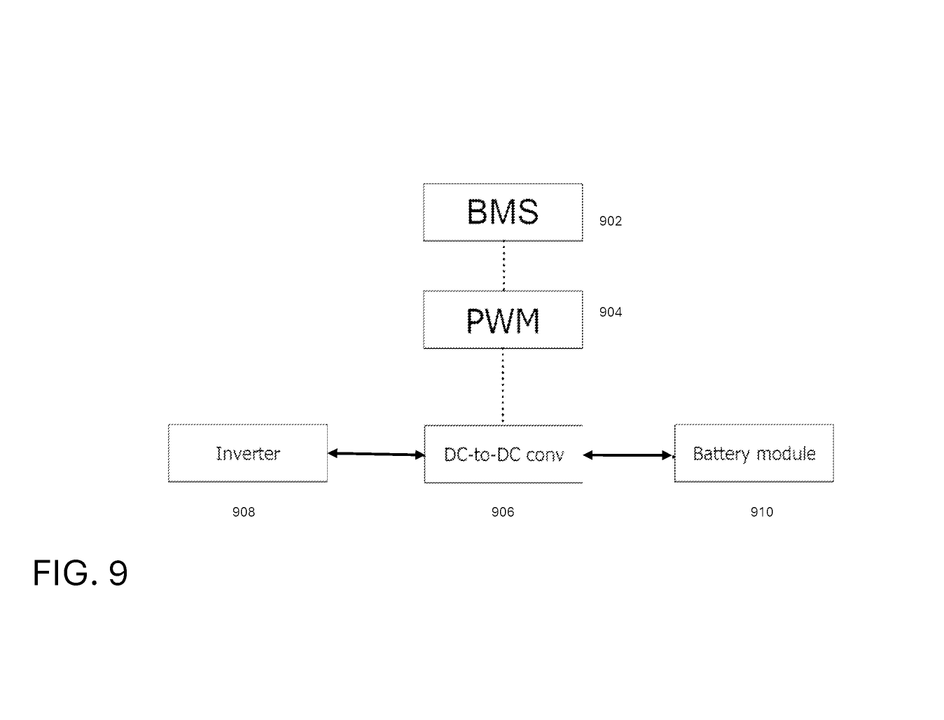

FIG. 9 shows an exemplary the switch mechanism of the battery balancing system. A battery management system (BMS) 902 signals a pulse width modifier (PWM) 904 to adjust the duty cycle of a signal being transmitted to a DC-to-DC converter 906. When the battery modules show no signs of abnormality, the PWM 904 may transmit a constant high state signal, resulting in a fixed DC input. The battery module 910 continues to stay powered the entire time and thus powers the inverter 908, converting the DC signal to AC. When the battery module shows abnormalities and current restrictions are needed to manage state-of-health (SOH) estimation 108 (FIG. 2), the PWM 904 transmits a variable DC output. The variable DC output oscillates between a low and a high state with a duty cycle of less than 100% (e.g., 75%, 50%, 25%, etc.)Therefore, when restricting current to manage the battery module 910, the DC-to-DC converter 906 modulates the current drawn from the battery module 910. The goal of modulating battery current is to allow the batteries to reach harmonized degradation, such that they all decay at a rate that minimizes their SOH differences, regardless of what the health of the battery was prior to being implemented into the battery management system 902. When the battery module shows abnormalities and the current restrictions do not fix state-of-health (SOH) estimation 108 (FIG. 2), the PWM 904 may transmit a DC output that effectively removes the defective battery module from the circuit.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a "means") used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. A battery management system comprising:
a controller configured to receive sensor information of battery cells in battery modules and further configured to produce a state-of-health (SOH) estimation for the battery cells or the battery modules based on the sensor information;
a storage configured to store the sensor information of each of the battery cells as SOH historical data for the corresponding battery cell;
the controller further configured to:
generate a SOH prediction for each of the battery cells based on the SOH historical data of the battery cell;
compare the SOH estimation to the SOH prediction; and
where the SOH estimation is within a predetermined threshold of the SOH prediction, the controller controls power converters to perform an SOH balancing between the one or more battery cells in the battery modules.

2. The battery management system of claim 1, wherein the sensor information includes at least one of current, voltage, and temperature, the battery management comprising one or more sensors operably connected to each of the battery cells and operably connected to the controller, the controller configured to receive the sensor information from the one or more sensors.

3. The battery management system of claim 2, the controller further configured to identify an estimated thermal runaway point of the battery cell based on the SOH historical data and the sensor information.

4. The battery management system of claim 3, the controller further configured to compare the potential runaway data to the estimated runaway point.

5. The battery management system of claim 4, wherein the controller is further configured to, where the potential runaway data is not within a predetermined threshold of the estimated runaway point, control to restrict current flow to a corresponding battery cell or battery module.

6. The battery management system of claim 5, wherein the controller is further configured to, where after restricting current flow to the corresponding battery cell or battery module the potential runaway data is still not within the predetermined threshold of the estimated runaway point, control to effectively disconnect the corresponding battery cell or battery module from the circuit and declare the corresponding battery cell or battery module faulty.

7. The battery management system of claim 6, wherein the controller is further configured to communicate information regarding faulty cells or modules as identified in claim 6 so that the faulty cells or modules may be serviced or replaced.7. The battery management system of claim 6, wherein the controller is further configured to communicate information regarding faulty cells or modules as identified in claim 6 so that the faulty cells or modules may be serviced or replaced.

8. The battery management system of claim 5, wherein the controller is further configured to:
determine a state of power (SOP) estimate based on current and voltage of each battery cell or module,
determine a SOP prediction for each battery cell or module based on the SOP estimate and a load demand on the battery cell or module.

9. The battery management system of claim 8, wherein the controller is configured to, where the SOP estimate is not within a predetermined threshold of the SOP prediction, control to restrict current flow to the corresponding battery cell or battery module.

10. The battery management system of claim 8, wherein the controller is configured to:
where the SOP estimate is within a predetermined threshold of the SOP prediction, predict a state of health (SOH) for the corresponding battery cell or module and compare the SOH prediction to the SOH estimation, and
where the SOH prediction is not within a predetermined threshold of the SOH estimation, control to restrict the current flow to the corresponding battery cell or module.

11. A method of managing battery modules in a circuit comprising:
producing a state-of-health (SOH) estimation through a controller for a plurality of battery cells based on a current, a voltage, and a temperature of each battery cell, in each of the battery modules;
storing the current, the voltage, and the temperature of each of the battery cells as SOH historical data for the battery cell;
generating an SOH prediction for each of the battery cells based on the SOH historical data of the battery cell; and
comparing the SOH estimation to the SOH prediction;
where the SOH estimation is within a predetermined threshold of the SOH prediction, performing an SOH balancing between the one or more battery cells in the battery modules.

12. The method of claim 11, wherein the state-of-health estimation of the battery cells is calculated by a controller of a battery management system, the controller configured to receive battery diagnostics from one or more sensors connected to each of the battery cells or modules.

13. The method of claim 12, further comprising identifying an estimated thermal runaway point of the battery cell based on the SOH historical data, the estimated thermal runaway point corresponding to one or more of a temperature, a H₂ gas concentration, and a CO₂ concentration.

14. The method of claim 13, further comprising receiving potential thermal runaway data from an H₂ gas sensor, a CO₂ gas sensor, and an environmental temperature sensor connected to the controller and each of the battery cells or modules, and comparing the potential runaway data to the estimated runaway point.

15. The method of claim 14, where the potential runaway data is not within a predetermined threshold of the estimated runaway point, restricting current flow to a corresponding battery cell or battery module.

16. The method of claim 15, where, after restricting current flow to the corresponding battery cell or battery module, the potential runaway data is still not within the predetermined threshold of the estimated runaway point, the corresponding battery cell or battery module is deemed to be faulty and is effectively disconnected from the circuit.

17. The method of claim 16, comprising:
communicating information regarding faulty cells or modules as identified in claim 17 so that the faulty cells or modules may be serviced or replaced.

18. The method of claim 15, further comprising:
determining a state of power (SOP) estimate based on current and voltage of each battery cell or module, and
determining an SOP prediction for each battery cell or module based on the SOP estimate and a load demand on the battery cell or module.

19. The method of claim 18, wherein where the SOP estimate is not within a predetermined threshold of the SOP prediction, control to restrict the current flow to the corresponding battery cell or module.

20. The method of claim 19, comprising:
where the SOP estimate is within a predetermined threshold of the SOP prediction, predicting a state of health (SOH) for the corresponding battery cell or module and comparing the SOH prediction to the SOH estimation, and
where the SOH prediction is not within a predetermined threshold of the SOH estimation, controlling to restrict the current flow to the corresponding battery cell or module.
